(19) United States
(12) Patent Application Publication
(10) Pub. No.: US 2015/0225636 A1
(43) Pub. Date: Aug. 13, 2015

(54) THERMALLY CONDUCTIVE POLYMER COMPOSITES CONTAINING MAGNESIUM SILICATE AND BORON NITRIDE

(71) Applicant: Laird Technologies, Inc., Earth City, MO (US)

(72) Inventors: Manjunatha Hosahalli Ramachandraiah, Nelamangala Taluk (IN); Sreejith Valiavalappil, Kannur (IN); Chitradurga L. Rao Aravinda, Nagarabhavi 2nd Stage (IN); Srinivasan Duraiswamy, Bangalore (IN)

(21) Appl. No.: 14/695,361

(22) Filed: Apr. 24, 2015

Related U.S. Application Data
(63) Continuation of application No. PCT/US2013/050765, filed on Jul. 16, 2013.

(30) Foreign Application Priority Data
Oct. 26, 2012 (IN) 3301/DEL/2012

(51) Int. Cl. C09K 5/14; C08K 3/34; C08K 3/38

(52) U.S. Cl. CPC C09K 5/14; C08K 3/38; C08K 3/34; C08K 2003/385

(57) ABSTRACT

A polymer composition is taught and claimed, the composition comprising polymer, boron nitride and magnesium silicate, wherein the composition has certain thermal conductivity and dielectric properties. Additionally, the composition may be injection moldable.

### CROSS-REFERENCE TO RELATED APPLICATIONS

This application is a continuation of International PCT Application No. PCT/US2013/050765 filed Jul. 16, 2013 (published as WO 2014/065910), which, in turn, claims the benefit of and priority to India Patent Application No. 3301/DEL/2012 filed Oct. 26, 2012. The entire disclosures of the above applications are incorporated herein by reference.

### FIELD

The invention, in some aspects, relates to thermally conductive plastics, particularly those containing boron nitride, magnesium silicate, and their derivatives.

### BACKGROUND

This section provides background information related to the present disclosure which is not necessarily prior art.

Thermally conductive plastics (TCP or TCPs) are polymers with thermally conductive and, frequently, electrically insulating materials used as fillers to achieve desired properties. When the fillers are used in the right proportions for the application, the final thermoplastic product may provide a means for thermal conductivity while remaining electrically insulating with high dielectric strength. Given the benefits of thermoplastics, those of skill in the art continue to search for fillers or combinations of fillers which offer enhancements on these properties.

### SUMMARY

This section provides a general summary of the disclosure, and is not a comprehensive disclosure of its full scope or all of its features.

In one aspect, a polymer composite is described that includes at least one plastic resin, magnesium silicate, and a form of boron nitride, where composite may be injection moldable.

In one embodiment, the polymer composite comprises at least 2% boron nitride by mass and about 1% magnesium silicate by volume. In another embodiment, the composite comprises at least 5% boron nitride by volume and about 2% magnesium silicate by volume. The polymer composite may exhibit a thermal conductivity of above 2 W/m-K and, in specific cases, may be as high as 18 W/m-K and above. The dielectric strength of composites may be above 4 kV/mm, and in specific cases may be as high as 28 KV/mm and above.

Additional embodiments and areas of industrial applicability will become apparent from the description provided herein. The description and specific examples in this summary are intended for purposes of illustration only and are not intended to limit the scope of the present technology.

### DETAILED DESCRIPTION

TCPs may be used in a variety of applications, including in the thermal management of electronic devices and gadgets through, for example, injection molding or thermosetting. Such materials may serve as substitutes for a metal or ceramic article, but where other properties are desired, such as lower density, higher strength and stiffness. In addition, TCPs being injection moldable offers flexibility in design, reduces secondary operations, and increases yield. Articles manufactured via conventional injection molding techniques may include, but are not limited to, light emitting diode (LED) heat sinks, electronic housings, mobile phone battery covers, wireless base stations, and other similar applications.

Magnesium silicate and its derivatives, commonly known as talc, may be used as a component in thermoplastics, including as filler in automotive applications to improve flame retardance.

Boron nitride may be used as filler in polymer composites to increase the thermal conductivity. One form of boron nitride used in conventional thermoplastics is hexagonal boron nitride (h-BN). The thermal conductivity of h-BN is directional dependent due to its hexagonal crystal structure. The average thermal conductivity of h-BN can vary between 250 and 300 W/m-K based on processing parameters.

Many types of h-BN provide a particularly desirable synergistic effect when included in a polymer composite along with certain ratios of magnesium silicate (3MgO.4SiO₂.H₂O). As will be seen in the following examples, these results are both surprising and novel in that the polymer composites exhibit properties that would not be predictable in light of the properties of a polymer composite with only one of either boron nitride or magnesium silicate. Additionally, the combination of the two materials in the disclosed ratios results in a polymer composite with enhanced injection moldability, which has been a problem when injection molding a polymer composite with only one of either boron nitride or magnesium silicate.

Several types of h-BN are commercially available, which are broadly classified as platelet h-BN, agglomerated h-BN, or spherical h-BN with various sizes ranging from few microns to several hundreds of microns.

Platelet h-BN has plate-like structures of h-BN crystals. Agglomerated h-BN may be a collection of h-BN crystals that are bonded together to form an individually identifiable particle, distinct from non-agglomerated particles such as platelets or crystalline domains. Spherical h-BN is also made out of a collection of h-BN crystals in a compressed spherical shape.

The above three forms of h-BN have both advantages and disadvantages during the processing of the polymer composites. Agglomerated h-BN has an advantage over others in that it is easy to feed through a conventional hopper in a twin screw extruder. However, the final composites disclosed herein frequently have h-BN crystals in the platelet form due to high shear rate in processing.

Magnesium silicate, commonly known as talc (hydrated silicate of magnesium—3MgO.4SiO₂.H₂O), is commonly used as a thermally insulating material. Several forms of magnesium silicate exhibit thermal conductivity of about 4 to 6 W/m-K. This value is 10 to 20 times higher than that of some polymers in which the thermal conductivity is limited to 0.2 to 0.4 W/m-K.

Talc may be classified into different forms and shapes. As used herein, much of the talc used is in the form of 3MgO.4SiO₂.H₂O. Like h-BN, talc has platelet structure. However, talc platelets have different aspect ratios which can be varied. In h-BN, the aspect ratio is limited due to the hexagonal shape of the platelets. High aspect ratio fillers used in polymer composites can improve the mechanical and thermal properties.

The art has not shown any instance where both magnesium silicate and boron nitride have acted synergistically to provide improved thermal conductivity and tunable electric properties. The following embodiments provide a thermoplastic, with a synergy between magnesium silicate and boron nitride, previously unseen in the art.

One embodiment is an injection moldable composition comprising at least one plastic resin, magnesium silicate, and a form of h-BN. The plastic resin may be any suitable polymer, such as polyamide 6, polycarbonate, polyphenylene sulfide and liquid crystalline polymers. The term “liquid-crystal polymer” used in various embodiments of the present technology is intended to mean a melt-processable polymer having such properties that the polymer molecular chains are regularly arranged parallel to each other in a molten state. Liquid-crystal polymers (LCPs) are a class of materials that combine properties of polymers with properties of liquid crystals.

The particle sizes of the agglomerated boron nitride may range from about 25 μm to about 250 μm, and are preferably between about 100 μm to about 150 μm. In another embodiment, the magnesium silicate (3MgO.4SiO₂.H₂O) has an aspect ratio around 1 referred to as general purpose talc (herein after GP talc). In yet another embodiment, the aspect ratio of the magnesium silicate (3MgO.4SiO₂.H₂O) is above 2 and referred to as aspect ratio talc (herein after AR talc). One of skill in the art will appreciate that aspect ratio, as used herein, refers to the ratio between an object's width to height.

Although polyamide 6, polycarbonate, polyphenylene sulfide, and liquid crystal polymer have been found to be suitable for the present application, additional polymers may be included in the composition, such as thermoplastics. Exemplary thermoplastics include, but are not limited, to polyamide-6,6, blends of polycarbonate & acrylonitrile butadiene styrene (PC-ABS), polyether imide, polyether ether ketone, polyether sulfone, polysulfone, polypropylene, and polybutylene terephthalate (PBT). Additionally, thermoplastic elastomers are among the thermoplastics embraced by this invention, non-limiting examples of which include polyester-based thermoplastic elastomers, and olefin-based thermoplastic elastomers. Blends of any of the aforementioned thermoplastics or thermoplastic elastomers are embraced by the scope of this disclosure.

When used in proper ratios, as will be seen in the examples below, the magnesium silicate and boron nitride provide a synergistic effect that imparts highly desirable qualities to the polymer compositions. The disclosed fillers enable the polymer to crystallize at an improved level, wherein the thermally conductive fillers achieve optimal spacing from the polymer spherulites. This spacing enables very high thermal conductivity as compared to polymer composites with hexagonal boron nitride or agglomerated boron nitride in the absence of talc. Additionally, this spacing enhances the polymer composite's dielectric properties.

As can be seen from the following examples, one embodiment of the present invention is a composition comprising a polymer that includes magnesium silicate in a total volume fraction of at least 2% and boron nitride in a total volume fraction in an effective amount so as to create a synergistic effect between the boron nitride and the magnesium silicate. In another embodiment, of the present invention, a composition comprises a polymer that includes magnesium silicate in a total volume fraction of at least 2% and boron nitride in a total volume fraction of at least 1%. Additional fillers may be added to the thermally conductive composition, including those that are thermally conductive.

In one embodiment, a composite includes a ratio of polymer, boron nitride, and magnesium silicate sufficient to generate a synergistic effect whereby the composite is thermally conductive. Preferably, the composite is additionally dielectric and injection moldable. Experiments show that the synergy is observed in ratios as low as 97:2:1 by weight volume (as will be seen in Composition K, below), though additional ratios with a higher percent volume of polymer are embraced by the spirit and scope of this disclosure.

The following examples and formulations are meant to illustrate the general principles and properties of certain embodiments of the present invention, and are not intended to limit the scope of the claims.

### Example 1

### LCP Based Thermally Conductive Composites

Case 1a:

A thermally conductive composite was prepared by melt mixing based on the formulation given in Table 1a.

TABLE 1a
Composition A (h-BN only)

| | | | | Sp. | Thermal |
|---|---|---|---|---|---|
| | Sp. | Vol. | Mass | Gravity of | Conductivity |
| Raw Material | Gravity | % | % | composite | (W/m-K) |
| LCP | 1.4 | 40 | 29.80 | 1.88 | 16 |
| Agglomerated | 2.22 | 60 | 70.20 | | |
| h-BN | | | | | |
| Total | | 100 | 100 | | |

The composition seen in Table 1a, referred to as Composition A, comprises 60 V % agglomerated h-BN in 40 V % liquid crystalline polymer (LCP). The resultant melt mixed composite, at 290 degrees Celsius, may not be suitable for injection molding. However, the composite is suitable for compression molding, providing a thermal conductivity of about 16 W/m-K.

Case 1b:

A thermally conductive composite was prepared by melt mixing based on the formulation given in Table 1b.

TABLE 1b
Composition B (Talc only)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| LCP | 1.4 | 40 | 25.30 | 2.21 | 2 |
| GP Talc | 2.74 | 60 | 74.70 | | |
| Total | | 100 | 100 | | |

The composition seen in Table 1b, referred to as Composition B, comprises 60 V % GP talc in 40 V % liquid crystalline polymer (LCP). The resultant melt mixed composite, at 290 degrees Celsius, may not be suitable for injection molding. However, it is suitable for compression molding. The resultant sample shows a thermal conductivity of about 2 W/m-K.

Case 1c:

A thermally conductive composite was prepared by melt mixing based on the formulation given in Table 1c.

TABLE 1c
Composition C (talc with h-BN)

| | | | | Sp. | Thermal |
|---|---|---|---|---|---|
| | Sp. | Vol. | Mass | Gravity of | Conductivity |
| Raw Material | Gravity | % | % | composite | (W/m-K) |
| LCP | 1.4 | 40 | 28.40 | 1.97 | 18 |
| Agglomerated | 2.22 | 45 | 50.67 | | |
| h-BN | | | | | |
| GP Talc | 2.74 | 15 | 20.92 | | |
| Total | | 100 | 100 | | |

The composition seen in Table 1c, referred to as Composition C, comprises 45 V % of agglomerated h-BN and 15 V % of GP talc in 40 V % liquid crystalline polymer (LCP). The resultant melt mixed composite at 290 degrees Celsius was found to be suitable for injection molding. The injection molded samples show a thermal conductivity of about 18 W/m-K.

In the three formulations seen in Example 1 above, the total volume percentage of the fillers was kept constant at 60. Composition A, comprising Agglomerated BN but no talc, is not injection moldable with current techniques. However, the compression molded samples showed a thermal conductivity of about 16 W/m-K. Composition B, comprising talc but no Agglomerated h-BN, is also not injection moldable with current techniques. After compression molding, samples show a thermal conductivity of only 2 W/m-K. This is because talc is a less thermally conductive material (5 W/m-K) compared to boron nitride (˜300 W/m-K), when measured through the plane of a hexagonal boron nitride crystal.

By comparison, Composition C, comprising 45 V % of the agglomerated h-BN with 15 V % of the GP talc, is injection moldable and the resultant samples show an enhanced thermal conductivity of about 18 W/m-K. Replacing the 15 V % of highly thermally conductive BN with the poor thermally conductive talc makes the composite injection moldable, and provides a marginal enhancement in the thermal conductivity, when compared to Composition A.

### Example 2

### Polyamide Based Thermally Conductive Composites

Case 2a:

A thermally conductive composite was prepared by melt mixing based on the formulation given in Table 2a.

TABLE 2a
Composition D (Injection moldable)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| Polyamide 6 | 1.14 | 85 | 74.4 | 1.3 | 4.7 |
| Agglomerated | 2.22 | 15 | 25.6 | | |
| h-BN | | | | | |
| Total | | 100 | 100 | | |

The composition seen in Table 2a, referred to as Composition D, comprises 15 V % agglomerated h-BN in 85 V % polyamide 6. The resultant melt mixed composite at 270 degrees Celsius is suitable for injection molding. The resultant samples show a thermal conductivity of about 4.7 W/m-K.

Case 2b:

A thermally conductive composite was prepared by melt mixing based on the formulation given in Table 2b.

TABLE 2b
Composition E (Injection moldable)

| | | | | Sp. | Thermal |
|---|---|---|---|---|---|
| | Sp. | Vol. | Mass | Gravity of | Conductivity |
| Raw Material | Gravity | % | % | composite | (W/m-K) |
| Polyamide 6 | 1.14 | 62 | 42.32 | 1.67 | 8 |
| Agglomerated | 2.22 | 15 | 19.94 | | |
| h-BN | | | | | |
| GP Talc | 2.74 | 23 | 37.74 | | |
| Total | | 100 | 100 | | |

The composition seen in Table 2b, referred to as Composition E, comprises 15 V % agglomerated h-BN and 23 V % of GP talc in 62 V % polyamide 6. The resultant melt mixed composite at 270 degrees Celsius is suitable for injection molding. The injection molded samples show a thermal conductivity of about 8 W/m-K.

In the two formulations seen in Example 2, the agglomerated h-BN volume percentage was kept constant as 15. However, adding 23V % of GP talc along with 15 V % of agglomerated h-BN enhances the thermal conductivity of the resultant injection moldable material, that being Composition E, by about 70% compared to that of agglomerated h-BN only Composition D.

### Example 3

### PC-ABS Based Thermally Conductive Composite

A thermally conductive composite was prepared by melt mixing based on the formulation given in Table 3, where PC-ABS is Polycarbonate/Acrylonitrile Butadiene Styrene.

TABLE 3
Composition F (Injection moldable)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| PC-ABS | 1.2 | 62 | 43.6 | 1.67 | 8 |
| Agglomerated | 2.22 | 15 | 19.5 | | |
| h-BN | | | | | |
| GP Talc | 2.74 | 23 | 36.9 | | |
| Total | | 100 | 100 | | |

The composition of Table 3, referred to as Composition F, comprises 15 V % agglomerated h-BN and 23 V % of GP talc in 62 V % PC-ABS. The resultant melt mixed composite at 270 degrees Celsius is suitable for injection molding. The injection molded samples show a thermal conductivity of about 8 W/m-K.

Comparing Composition F to Composition E of Example 2 above, the ratio of the raw materials is kept the same, but for the change in the base polymer. Replacing the more crystalline polymer, polyamide 6, with a more amorphous polymer in PC-ABS did not affect the thermal conductivity or injection moldability.

### Example 4

### Polyphenylene Sulfide Based Thermally Conductive Composite

A thermally conductive composite was prepared by melt mixing based on the formulation given in Table 4.

TABLE 4
Composition G (Injection moldable)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| Polyphenylene | 1.35 | 62 | 46.5 | 1.79 | 8 |
| sulfide | | | | | |
| Agglomerated | 2.22 | 15 | 18.3 | | |
| h-BN | | | | | |
| GP Talc | 2.74 | 23 | 35.1 | | |
| Total | | 100 | 100 | | |

The composition of Table 4, referred to as Composition G, comprises 15 V % agglomerated h-BN and 23 V % of GP talc in 62 V % Polyphenylene sulfide. The resultant melt mixed composite at 290 degrees Celsius is suitable for injection molding. The injection molded samples show a thermal conductivity of about 8 W/m-K.

Composition G maintains the same ratio of base polymer to agglomerated h/BN to talc as that of Composition F and Composition E, but is distinguished from those other compositions in that polyamide 6 was replaced with high heat polyphenylene sulfide. As can be seen in Table 4, this substitution did not affect the thermal conductivity and injection moldability. This infers that the observed synergetic effect between talc and BN is not only independent of polymer, but is suitable for all high heat polymer matrices and their blends.

It is clear from these examples that the observed synergetic effect between talc and BN is independent of the polymer used in the composition. Thus, the inclusion of a synergistic ratio of talc and BN in a variety of polymer matrices and their blends, beyond those disclosed herein, is fully embraced and supported by the spirit and scope of this disclosure.

### Example 5

### Agglomerated BN Vs. Platelet BN

A thermally conductive composite was prepared by melt mixing based on the formulation given in Table 5

TABLE 5
Composition H (Injection moldable)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| Polyamide 6 | 1.14 | 62 | 42.3 | 1.67 | 8 |
| Platelet h-BN | 2.22 | 15 | 19.9 | | |
| GP Talc | 2.74 | 23 | 37.7 | | |
| Total | | 100 | 100 | | |

The composition of Table 5, referred to as Composition H, comprises 15 V % platelet h-BN and 23 V % of GP talc in 62 V % polyamide 6. The resultant melt mixed composite at 270 degrees Celsius is suitable for injection molding. The injection molded samples show a thermal conductivity of about 8 W/m-K.

Composition H maintains the same ratio of elements as that of Composition E of Example 2, except that the type of h-BN is changed. Replacing the agglomerated h-BN with non-agglomerated platelet h-BN in the same volume percentage did not affect the thermal conductivity and injection moldability. This infers that the observed synergetic effect between talc and BN is independent of h-BN types. It is suitable for all types of h-BN and their combinations.

### Example 6

### GP Talc Vs. AR Talc

A thermally conductive composite was prepared by melt mixing based on the formulation given in Table 6.

TABLE 6
Composition I (Injection moldable)

| | | | | Sp. | Thermal |
|---|---|---|---|---|---|
| | Sp. | | | Gravity of | Conductivity |
| Raw Material | Gravity | Vol. % | Mass % | composite | (W/m-K) |
| Polyamide 6 | 1.14 | 62 | 42.3 | 1.67 | 8 |
| Platelet h-BN | 2.22 | 15 | 19.9 | | |
| AR Talc | 2.75 | 23 | 37.7 | | |
| Total | | 100 | 100 | | |

The composition in Table 6, referred to as Composition I, comprises 15 V % platelet h-BN and 23 V % of AR talc in 62 V % polyamide 6. The resultant melt mixed composite at 270 degrees Celsius is suitable for injection molding. The injection molded samples show a thermal conductivity of about 8 W/m-K.

In Composition I, the ratio of the elements is kept the same as that of Composition E of Example 2, but the type of the talc in the composition is changed. Replacing the GP talc with high aspect ratio AR talc in the same volume percentage did not affect the thermal conductivity and injection moldability. This infers that the observed synergetic effect between talc and BN is independent of talc types. It is suitable for all types of talc and their combinations. Further, the AR talc enhances the mechanical properties due to their high aspect ratio.

### Example 7

### Polycarbonate Based Thermally Conductive Composites with Low Filler Loadings

A thermally conductive composite was prepared by melt mixing based on the formulation given in Table 7.

TABLE 7
Composition J (Injection moldable)

| | | | | Sp. | Thermal |
|---|---|---|---|---|---|
| | Sp. | Vol. | Mass | Gravity of | Conductivity |
| Raw Material | Gravity | % | % | composite | (W/m-K) |
| Polycarbonate | 1.2 | 93 | 87.1 | 1.28 | 4 |
| agglomerated h-BN | 2.22 | 5 | 8.7 | | |
| AR Talc | 2.74 | 2 | 4.3 | | |
| Total | | 100 | 100 | | |

The composition of Table 7, referred to as Composition J, comprises 5 V % of agglomerated h-BN and 2 V % of AR talc in 93 V % polycarbonate. The resultant melt mixed composite at 280 degrees Celsius is suitable for injection molding. The injection molded samples show a thermal conductivity of about 4 W/m-K.

Another thermally conductive composite was prepared by melt mixing based on the formulation given in Table 8.

TABLE 8
Composition K (Injection moldable)

| | | | | Sp. | Thermal |
|---|---|---|---|---|---|
| | Sp. | Vol. | Mass | Gravity of | Conductivity |
| Raw Material | Gravity | % | % | composite | (W/m-K) |
| Polycarbonate | 1.2 | 97 | 94.2 | 1.23 | 2 |
| Agglomerated h-BN | 2.22 | 2 | 3.6 | | |
| AR Talc | 2.74 | 1 | 2.2 | | |
| Total | | 100 | 100 | | |

Remarkably and surprisingly, the synergistic effect of the BN and talc is present even in very low loading levels. This phenomenon is seen in Compositions J and K, where the total filler loading is very low (7 V % and 3%, respectively), yet a significant thermal conductivity is observed (4 W/m-K and 2 W/m-K, respectively).

In each instance, the compositions maintain high dielectric strength, as can be seen by the examples shown in Table 9 below.

TABLE 9

| Sample ID | Polymer | Dielectric Strength (KV/mm) |
|---|---|---|
| C | Liquid Crystalline | 27 |
| | Polymer | |
| E | Polyamide 6 | 22 |
| F | PC-ABS | 19 |
| G | Polyphenylene sulfide | 22 |
| J | Polycarbonate | 17 |

As it can be seen in Table 9, each of these compositions provided highly effective dielectric strength results. Using the results in Table 9, theoretically calculated dielectric strength of compositions A and B are in the range of 12 to 15 KV/mm.

From a practical point of view, a pressing need in the art has been satisfied. Through the presence of the synergy between the boron nitride and the talc, the inventors created a thermally conductive polymer composition at a significantly reduced cost to those currently available in the marketplace. Conventional thermoplastics that contain only boron nitride must be loaded with a substantial amount of BN to generate desired thermal properties. Talc is substantially less expensive than boron nitride, and thus the combination of talc and boron nitride at low fill levels (to the tune of 2%-7%, or less), while maintaining impressive thermal conductivity and low electrical conductivity, provides a significant and previously unseen advantage over the art. The low load levels disclosed herein provided the added advantage of flexibility with respect to injection molding, a benefit unseen in high load compositions of boron nitride in the absence of talc.

An added advantage of some of the embodiments described above is the flexibility with respect to the color of the molded thermoplastic article. Many of the compositions disclosed herein are white in color, and various known colorants may be added to the thermoplastic composite with no loss of thermal or dielectric performance. Articles manufactured via conventional injection molding techniques may include, but are not limited to, light emitting diode (LED) heat sinks, electronic housings, mobile phone battery covers, wireless base stations, and other similar applications. Composites manufactured in accordance with the teachings herein meet most industry standard requirements for electronic applications, and additionally possess a low coefficient of thermal expansion.

Articles manufactured from the thermally conductive dielectric composites of the present disclosure may be formed using manufacturing processes such as extrusion, injection molding, and compression molding, though it is preferred that the present composites be formed through injection molding. For example, injection molding allows the present composites to be formed into many different shapes and sizes using available equipment and systems. These fabrication processes may also be performed in a continuous fashion (e.g., using a twin-screw extruder) providing benefits with respect to production time and cost-effectiveness.

The preceding description of technology is merely exemplary in nature of the subject matter, manufacture, and use of the invention, and is not intended to limit the scope, application, or uses of the invention as claimed in this application or in such other applications as may be filed claiming priority to this application, or patents issuing therefrom. The following definitions and non-limiting guidelines must be considered in reviewing the description of the technology set forth herein.

The headings (such as “Background” and “Summary”) and subheadings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. But other embodiments may also be preferred, under the same or other circumstances. Furthermore, the recitation of one or more preferred embodiments does not imply that other embodiments are not useful, and is not intended to exclude other embodiments from the scope of the technology.

As referred to herein, all compositional percentages are by weight of the total composition, unless otherwise specified. As used herein, the word “comprise”, “include,” and variants thereof are intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A thermally conductive composite comprising a polymer, at least about 2% boron nitride by volume, and at least about 1% magnesium silicate by volume.

2. The thermally conductive composite of claim 1, comprising at least about 5% boron nitride by volume and at least about 2% magnesium silicate by volume.

3. The thermally conductive composite of claim 2, comprising at least about 15% boron nitride by volume and at least about 23% magnesium silicate by volume.

4. The thermally conductive composite of claim 1, wherein:
the polymer is selected from the group consisting of polyamide 6, polyamide 6,6, a polyester, polyphenylene sulfide, polycarbonate, acrylonitrile butadiene styrene, liquid crystalline polymer or any combination thereof; and/or
the boron nitride is selected from the group consisting of agglomerated hexagonal boron nitride, platelet hexagonal boron nitride, and spherical hexagonal boron nitride.

5. The thermally conductive composite of claim 1, wherein the chemical composition of magnesium silicate is 3MgO.4SiO₂.H₂O, with aspect ratio about 1 or above 2.

6. The thermally conductive composite of claim 1, wherein:
the composite exhibits a thermal conductivity of at least about 2 W/m-K, at least about 4 W/m-K, or at least about 8 W/m-K; and/or
the composite exhibits an average dielectric strength of at least about 4 kV/mm, at least about 15 kV/mm, or at least about 20 kV/mm.

7. The thermally conductive composite of claim 1, wherein the composite is injection moldable.

8. The thermally conductive composite of claim 7, wherein:
the polymer comprises liquid crystalline polymer, the boron nitride comprises agglomerated hexagonal boron nitride, and the chemical composition of magnesium silicate is 3MgO.4SiO₂.H₂O with aspect ratio about 1; and/or
the composite comprises about 40% polymer by volume, about 45% boron nitride by volume, and about 15% magnesium silicate by volume, and the composite exhibits a thermal conductivity of at least about 18 W/m-K, and the composite exhibits a dielectric strength of at least about 27 kV/mm.

9. The thermally conductive composite of claim 7,
the polymer comprises polyamide 6, the boron nitride comprises agglomerated hexagonal boron nitride, and the chemical composition of magnesium silicate is 3MgO.4SiO₂.H₂O with aspect ratio about 1; and/or
the composite comprise about 62% polymer by volume, about 15% boron nitride by volume, and about 23% magnesium silicate by volume, and the composite exhibits a thermal conductivity of at least about 8 W/m-K, and the composite exhibits a dielectric strength of at least about 22 kV/mm.

10. The thermally conductive composite of claim 7,
the polymer comprises polycarbonate acrylonitrile butadiene styrene (PC-ABS), the boron nitride comprises agglomerated hexagonal boron nitride, and the chemical composition of magnesium silicate is 3MgO.4SiO₂.H₂O with aspect ratio about 1; and/or
the composite comprise about 62% polymer by volume, about 15% boron nitride by volume, and about 23% magnesium silicate by volume, and the composite exhibits a thermal conductivity of at least about 8 W/m-K, and the composite exhibits a dielectric strength of at least about 19 kV/mm.

11. The thermally conductive composite of claim 7,
the polymer comprises polyphenylene sulfide, the boron nitride comprises agglomerated hexagonal boron nitride, and the chemical composition of magnesium silicate is 3MgO.4SiO₂.H₂O with aspect ratio about 1; and/or
the composite comprise about 62% polymer by volume, about 15% boron nitride by volume, and about 23% magnesium silicate by volume, and the composite exhibits a thermal conductivity of at least about 8 W/m-K, and the composite exhibits a dielectric strength of at least about 22 kV/mm.

12. The thermally conductive composite of claim 7,
the polymer comprises polyamide 6, the boron nitride comprises platelet hexagonal boron nitride, and the chemical composition of magnesium silicate is 3MgO.4SiO₂.H₂O with aspect ratio about 1; and/or
the composite comprise about 62% polymer by volume, about 15% boron nitride by volume, and about 23% magnesium silicate by volume, and the composite exhibits a thermal conductivity of at least about 8 W/m-K.

13. The thermally conductive composite of claim 7,
the polymer comprises polyamide 6, the boron nitride comprises platelet hexagonal boron nitride, and the chemical composition of magnesium silicate is 3MgO.4SiO₂.H₂O with aspect ratio above 2; and/or
the composite comprise about 62% polymer by volume, about 15% boron nitride by volume, and about 23% magnesium silicate by volume, and the composite exhibits a thermal conductivity of at least about 8 W/m-K.

14. The thermally conductive composite of claim 7,
the polymer comprises polycarbonate, the boron nitride comprises agglomerated hexagonal boron nitride, and the chemical composition of magnesium silicate is 3MgO.4SiO₂.H₂O with aspect ratio above 2; and/or
the composite comprise about 93% polymer by volume, about 5% boron nitride by volume, and about 2% magnesium silicate by volume, and the composite exhibits a thermal conductivity of at least about 4 W/m-K, and the composite exhibits a dielectric strength of at least about 17 kV/mm.

15. The thermally conductive composite of claim 7,
the polymer comprises polycarbonate, the boron nitride comprises agglomerated hexagonal boron nitride, and the chemical composition of magnesium silicate is 3MgO.4SiO₂.H₂O with aspect ratio above 2; and/or
the composite comprise about 97% polymer by volume, about 2% boron nitride by volume, and about 1% magnesium silicate by volume, and the composite exhibits a thermal conductivity of at least about 2 W/m-K.

16. The thermally conductive composite of claim 1, comprising:
about 62% polymer by volume, about 15% boron nitride by volume, and about 23% magnesium silicate by volume; or
about 40% polymer by volume, about 45% boron nitride by volume, and about 15% magnesium silicate by volume; or
about 93% polymer by volume, about 5% boron nitride by volume, and about 2% magnesium silicate by volume; or
about 97% polymer by volume, about 2% boron nitride by volume, and about 1% magnesium silicate by volume.

17. A thermally conductive composite comprising polymer, boron nitride, and magnesium silicate, where the polymer, boron nitride, and magnesium silicate are present in amounts sufficient to generate a synergistic effect whereby the composite exhibits a thermal conductivity of at least 2 W/m-K.

18. The thermally conductive composite of claim 17, wherein the composite exhibits a thermal conductivity of at least about 8 W/m-K.

19. A thermally conductive composite comprising a polymer, at least 2% boron nitride by volume, and at least 1% magnesium silicate by volume, wherein:
the polymer is selected from the group consisting of polyamide 6, polyamide 6,6, a polyester, polyphenylene sulfide, polycarbonate, acrylonitrile butadiene styrene, liquid crystalline polymer or any combination thereof;
the boron nitride is selected from the group consisting of agglomerated hexagonal boron nitride, platelet hexagonal boron nitride, and spherical hexagonal boron nitride; and
the chemical composition of magnesium silicate is 3MgO.4SiO₂.H₂O with aspect ratio of 1 or above.

20. The thermally conductive composite of claim 19, wherein:
the composite comprises at least about 5% boron nitride by volume and at least about 2% magnesium silicate by volume, or at least about 15% boron nitride by volume and at least about 23% magnesium silicate by volume; and/or
the composite exhibits a thermal conductivity of at least about 2 W/m-K or at least about 4 W/m-K.
